(19) United States
(12) Patent Application Publication
(10) Pub. No.: US 2004/0073874 A1
(43) Pub. Date: Apr. 15, 2004

(54) Device for retrieving data from a knowledge-based text

(76) Inventors: Thierry Poibeau, Fontenay Aux Roses (FR); C?eacute;lestin Sedogbo, Beynes (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/467,937

(22) PCT Filed: Feb. 19, 2002
(86) PCT No.: PCT/FR02/00631

(30) Foreign Application Priority Data
Feb. 20, 2001 (FR) 01/02270

(51) Int. Cl. G06F 17/00; G06N 5/00; G06F 15/18; G06G 7/00

(52) U.S. Cl. 715/531; 706/45; 706/7

(57) ABSTRACT

The invention relates to a device and a method for extracting information from an unstructured text, said information including relevant instances of classes/entities searched for by the user and relations between these classes/entities. The device and method improve in a semi-automatic manner on a given domain. The transition from one domain to a new domain is also highly facilitated by the device and method of the invention.

The present invention is in the field of extraction of information from unstructured texts. More specifically, it enables the formation and enrichment of a database of knowledge specific to a domain, improving the effectiveness of the extraction.

Information extraction (IE) is distinct from information retrieval (IR). Information retrieval involves finding texts containing a combination of words that are the object of the search or, where necessary, a combination close to the original, the degree of closeness being used to arrange the collection of texts containing said combination in order of relevance. Information retrieval is used especially in document searches and, increasingly, by the general public (use of search engines on the Internet).

Information extraction involves searching through a collection of unstructured texts for all the information (and only that information) having an attribute (for example all proper names, company heads, heads of state, etc.) and arranging all instances of the attribute in a database so as to then process them. Information extraction is used especially in business intelligence and in civilian or military intelligence.

The prior art in information extraction is well represented by the work and papers presented at the Message Understanding Conferences which take place every two years in the USA (references: Proceedings of the 5^{th}, 6^{th} and 7^{th} Message Understanding Conference (MUC-5, MUC-6, MUC-7), Morgan Kaufmann, San Mateo, Calif., USA). The selection algorithms have, for a long time now, implemented finite state machines (FSMs) or finite state transducers (FSTs). See in particular U.S. Pat. Nos. 5,610,812 and 5,625,554.

The relevance of the results of these algorithms is however highly dependent on the semantic proximity of the texts which are processed. If semantic proximity is no longer assured, as in the case of a change of domain, the algorithms must be completely reprogrammed, which is a long and costly process.

U.S. Pat. Nos. 5,796,926 and 5,841,895 disclose the use of certain learning processes for programming in a semi-automatic manner the finite state machine algorithms. The processes of this prior art are limited to the learning of the syntactic relations in the context of a sentence, which involves the need to resort again in a very important way to manual programming.

The present invention solves this problem by enabling the learning of other types of relations and by extending the field of the learning to the whole of a collection of texts of a domain.

To these ends, the invention proposes a device for extracting information from a text including an extraction module and a learning module cooperating with each other and comprising means for automatically selecting in the text the contexts of instance of classes/entities of information to be extracted, for automatically selecting from these contexts those which are relevant for a domain and for enabling the user to modify this latter selection such that the learning module will improve the next output of the extraction module, characterized in that the extraction module additionally includes means for identifying relations existing in the text between the relevant entities at the output of the means.

The invention also proposes a method for extracting information from a text including a learning process and a selection process, the selection process including a step of automatic selection in the text of contexts of instance classes/entities of the information to be extracted, a step of automatic selection from these contexts of those which are relevant for a domain and a step of modification by the user of outputs of the previous step, the modified outputs being taken into account in a learning process to improve the next result of the selection process, characterized in that the selection process additionally includes steps to identify the relations existing in the text between the relevant entities at the output of the steps of the selection process.

The invention will be better understood and its various features and advantages will become apparent from the description that follows of an example embodiment and from its accompanying figures, of which:

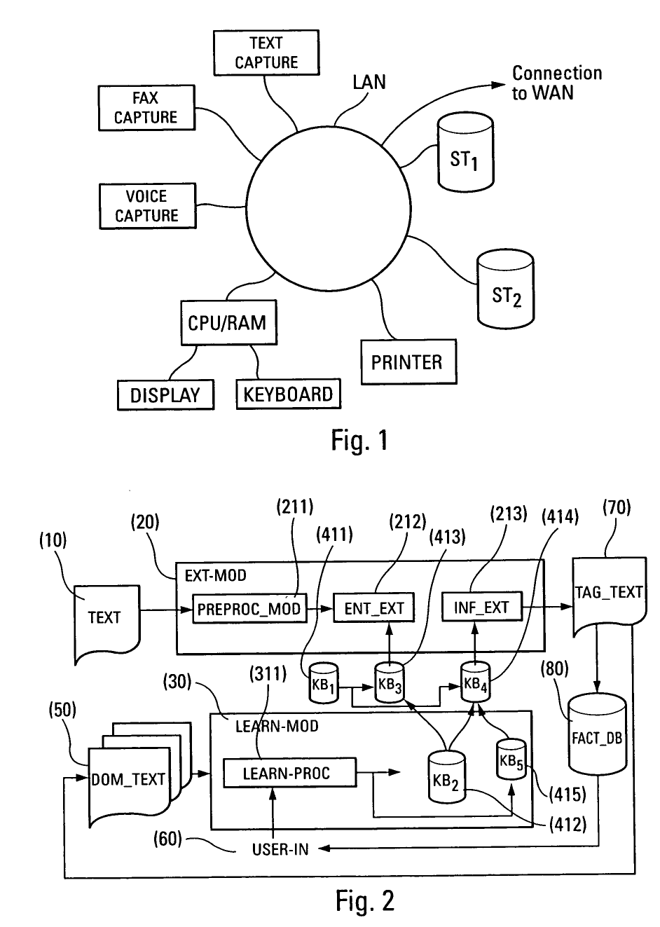

FIG. 1 discloses a hardware embodiment of the device;

FIG. 2 shows the architecture of the device according to the invention;

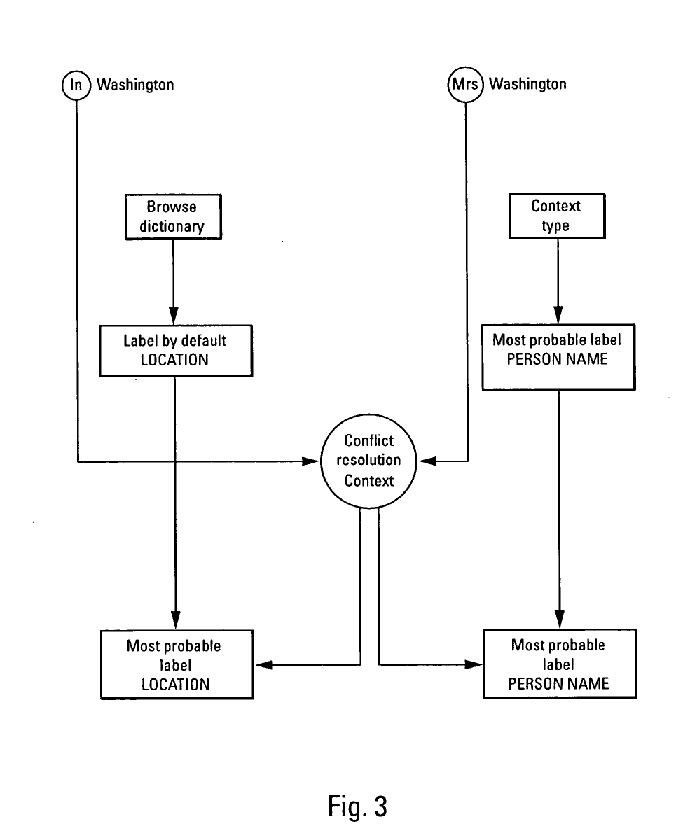

FIG. 3 shows the flowchart for conflict resolution according to the context;

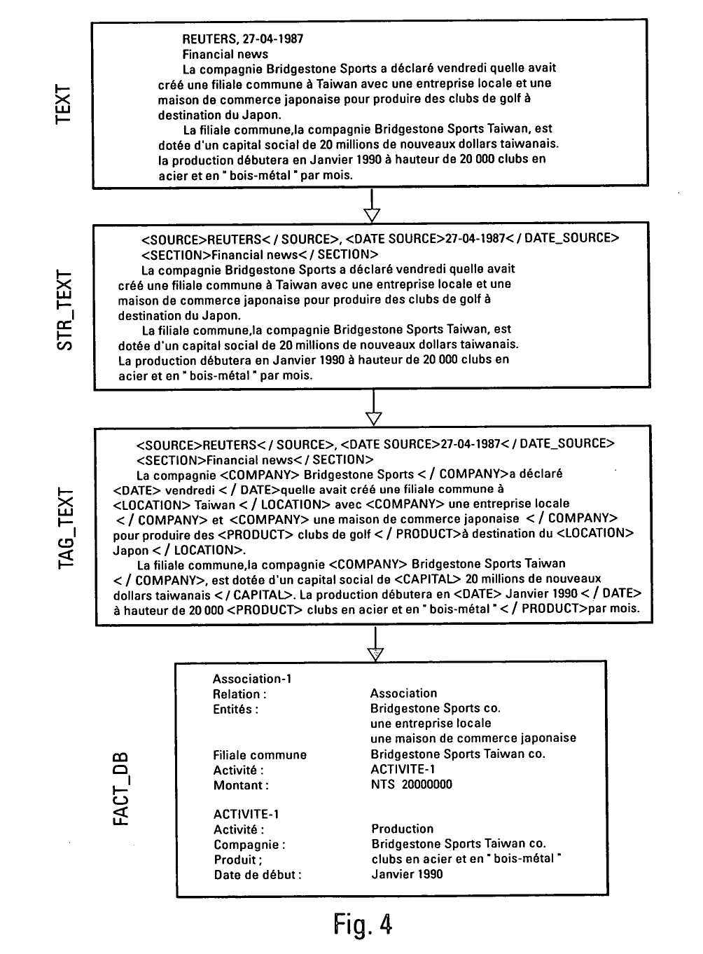

FIG. 4 shows the sequencing of the steps of the method according to the invention;

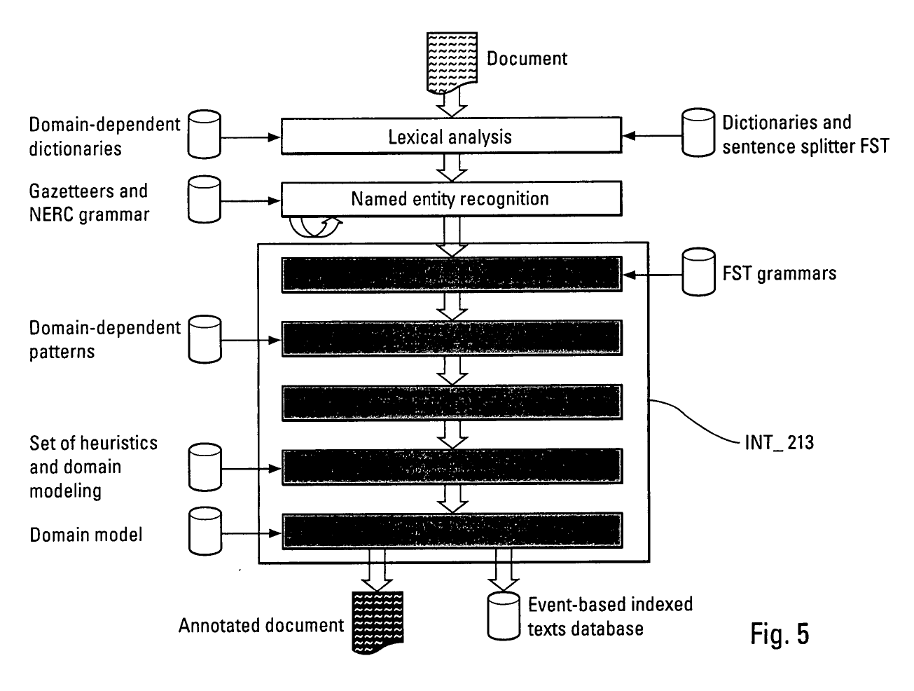

FIG. 5 shows the flowchart of the relations between the entities;

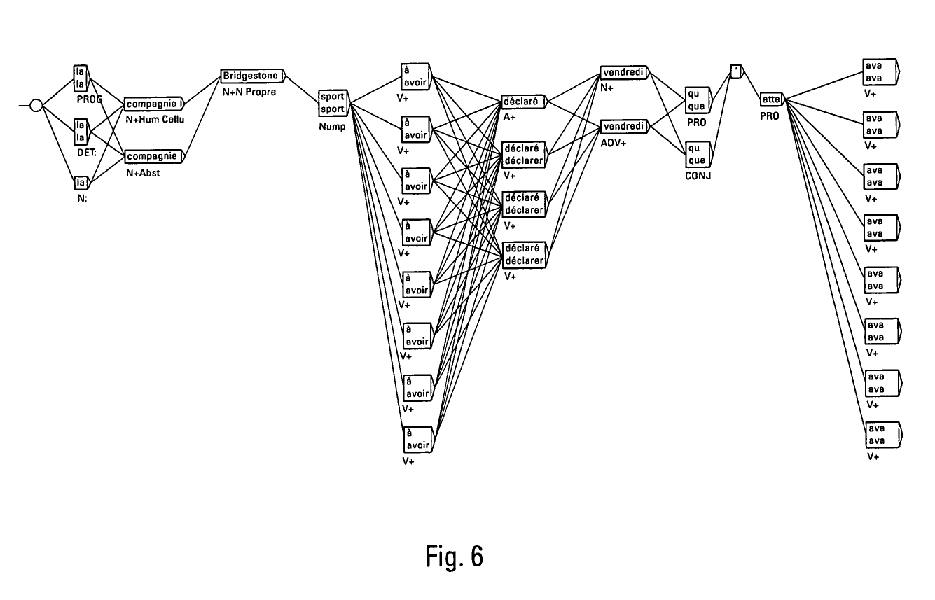

FIG. 6 shows an example morphosyntactic analysis;

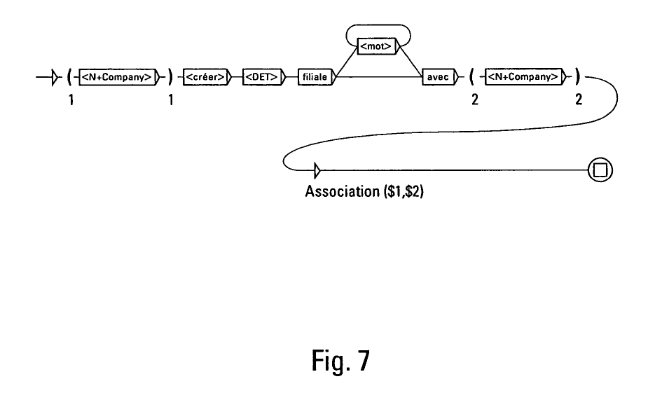

FIG. 7 illustrates an example of transduction;

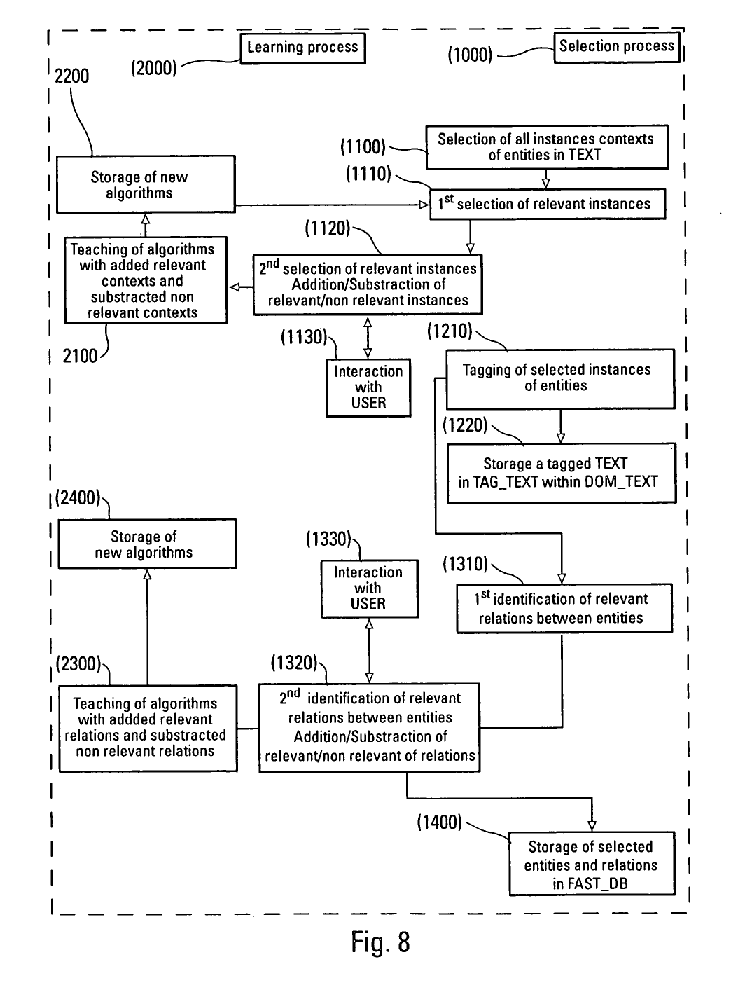

FIG. 8 illustrates the sequencing of selection steps on an example;

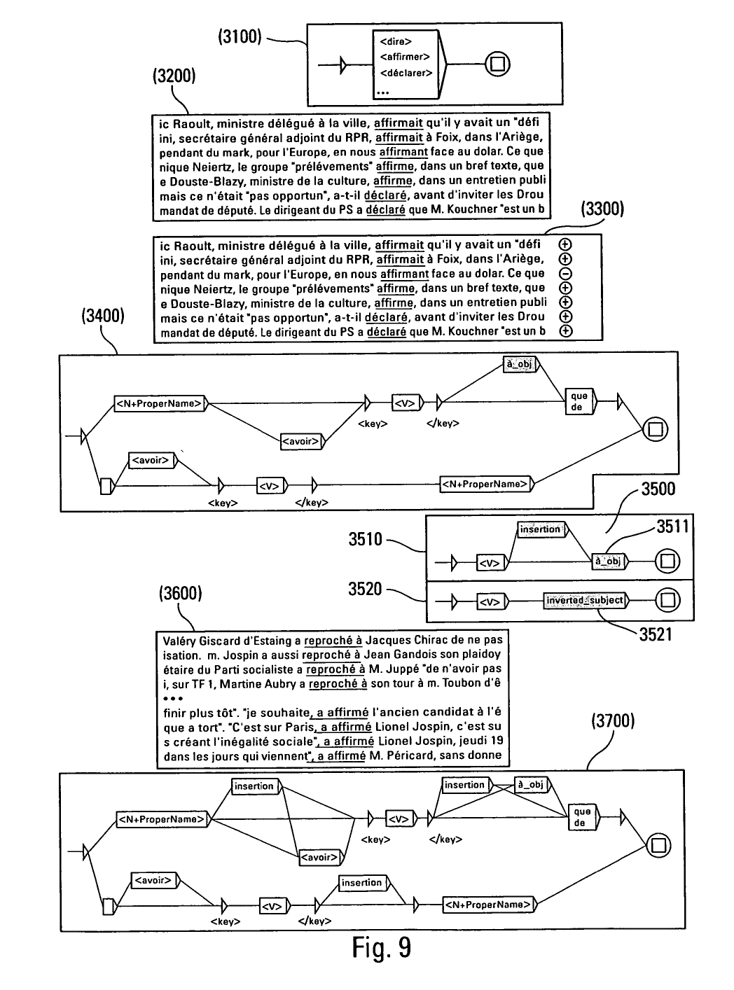

FIG. 9 illustrates the sequencing of learning steps on another example.

The accompanying drawings include a number of elements, in particular textual, of certain character. As a consequence, the drawings will be able to not only illustrate the description but also contribute if necessary to the definition of the invention.

To be more comprehensible, the detailed description deals with the file elements in natural language. For example, REUTERS will be used as the agency name (SOURCE). However, in computer science terms REUTERS is a character string represented by corresponding bytes. The same is true for the other information-processing-related objects: in particular dates, numerical values. Tagging is also an established operation which, purely by way of nonlimiting example, is illustrated by the language XML.

As shown in FIG. 1, the device may include a central processing unit and its associated memory (CPU/RAM) with a keyboard and monitor. The central processing unit will be advantageously connected to a local area network, itself possibly connected to a public or private wide area network (DISPLAY), if necessary by secured links. The collections of texts to be processed will be available in several types of alphanumeric format (processing and text, HTML or XML) on storage means (ST_1, ST_2) which will for example be redundant disks connected to the local area network.

These storage means will also include texts that have undergone processing according to the invention (TAG_TEXT) and various corpora of texts by domain (DOM_TEXT) with the appropriate indexes. Also stored on these disks will be the database(s) (FACT_DB) fed by the information extraction. The database will advantageously be of the relational type or object type. The data structure will be defined in a manner known to those skilled in the art according to the application specification or generated by the application (see for example the FACT_DB window in FIG. 4).

The texts to be processed (TEXT) can be imported to the storage means (ST_1, ST_2) by diskette or any other removable storage means or they can come from the wide area network, directly in a format compatible with the PREPROC_MOD sub-module (FIG. 2).

They can also be captured on one of the networks connected to the device according to the invention by capture devices.

This could include alphanumeric messages from for example a messaging system “text capture”, from scanned documents or faxes “fax capture” or from voice messages “voice capture”. The computer peripheral equipment enabling this capture and the software used to convert them to text format (image recognition and speech recognition) are commercially available. In the case of intelligence applications, it may be useful to carry out an interception and a real-time processing of documents exchanged over wired or wireless communication networks. In this case, the specific listening devices will be integrated in the system upstream of the capture peripheral equipment.

The device according to the invention, such as the one shown in block-diagram form in FIG. 2, includes an extraction module (20) or “EXT_MOD” to which the text to be processed (“TEXT”, 10) is presented.

Said extraction module (20) includes a first preprocessing program (“PREPROC_MOD”, 211) which recognizes the structure of the document in order to extract information from it. Structured documents enable simple extraction, without linguistic analysis, since they have headers or characteristic structures (electronic mail headers, agency dispatch block). Thus, in the example of FIG. 4, the agency dispatch block in the STR_TEXT window includes:

the agency name (SOURCE=“REUTERS”),

the date of dispatch (DATE_SOURCE=27-04-1987),

the rubric title (SECTION=“Financial news”).

To recognize specific entities, it is sufficient to recognize the document type (agency dispatch) from the presence of a characteristic block. The three entities are then taken from their position determined in the block.

The extraction module (20) also includes a second program to extract the entities (“ENT_EXT”, 212), that is to say to recognize the names of persons, of company locations and the expressions specified in the domain considered.

The block of the TAG_TEXT window of FIG. 4 shows the entities/expressions with the class that has been attributed to them by tags:

| | | |
|---|---|---|
| “Bridgestone Sports” | −> | COMPANY |
| “vendredi” | −> | DATE |
| “Taiwan” | −> | LOCATION |
| “une entreprise locale” | −> | COMPANY |
| “clubs de golf” | −> | PRODUCT |
| “Japon” | −> | LOCATION |
| “Bridgestone Sports Taiwan | −> | COMPANY |
| “20 millions de nouveaux dollars | | |
| taiwanais” | −> | CAPITAL |
| “janvier 1990” | −> | DATE |
| “clubs en acier et en bois-metal” | −> | PRODUCT |

The recognition of entities/expressions will call upon the dictionary (KB₃, 413) which itself is fed by general knowledge (KB₁, 411) and learned knowledge (KB₂, 412).

For example “Taïwan” and “Japon” are location names (LOCATION) appearing in the dictionary KB₁.

The recognition will also use a grammar (KB₄, 414), which itself is fed by general knowledge (KB1, 411) and learned knowledge (KB₂, 412). For example, “Bridgestone Sports” and “Bridgestone Sports Taïwan” are recognized as instances of the entity COMPANY since they appear in the structure of two sentences as qualifiers of the word “compagnie” (meaning “company”). Likewise, “clubs de golf” and “clubs en acier” et en “bois-metal”” are recognized as instances of the entity “PRODUCT” since they are respectively direct objects of the verb “produire” (“to produce”) and adjuncts of the verb “débuter” having the subject “production”.

Dictionary and grammar must be able to be combined to remove ambiguities. For example, the three words “Bridgestone Sports Taïwan” are recognized as belonging to the same instance of COMPANY although “Bridgestone Sports” has already been recognized as instance of COMPANY and “Taïwan” an instance of LOCATION and therefore both belonging to the dictionary (KB₂, 413). This is because there is no punctuation or preposition separating the two groups in the sentence. Hence it follows that a new word is being dealt with made up of two previous groups.

Several types of algorithms will be used at this stage. These algorithms are implemented in the selection step (1000) represented in FIG. 3, more particularly at steps (1100) (“Selection of all instances and contexts of entities in TEXT”) and (1110) (“1st selection of relevant instances”). These steps implemented by the computer automatically, that is without user intervention, are followed by a semi-automatic step (1120) (“2nd selection of relevant instances—Addition/Subtraction of relevant/non-relevant instances”) at which the user intervenes by a step (1130) by selecting the instances/contexts of the entity which appear relevant to him. This step is displayed in the window (3300) of FIG. 5. By way of example, mention is made of:

the reuse of partial rules; the method described uses the elements already found and the grammar rules for recognizing proper names in order to extend the coverage of the initial system. Therefore this amounts to a case of explanation-based learning. The mechanism is based on grammar rules with the involvement of unknown words. For example, the grammar can recognize Mr Kassianov as being a name of a person even if Kassianov is an unknown word. The isolated instances of the word can henceforth be labeled as person name. The learning is in this case used as an inductive mechanism using knowledge from the system (the grammar rules) and the entities found beforehand (the set of positive examples) to improve performance;

the use of discourse structures; discourse structures are another source for acquiring knowledge, like enumerations, easily identifiable for example by the presence of a certain number of person names, separated by connectors (commas, subordination conjunction “and” or “or” etc.). For example, in the following sequence: <PERSON_NAME> Kassianov </PERSON_NAME>, <UNKNOWN> Kostine </UNKNOWN> and <PERSON_NAME> Primakov (/PERSON_NAME), Kostine is labeled as an unknown word. The system infers from the context (the word Kostine appears in an enumeration of person names) that the word Kostine refers to a person name, even though in this case it is an isolated person name which cannot be typed from the dictionary or from other instances in the text.

the management of conflicts between labeling strategies; these learning strategies lead to type conflicts, particularly when the dynamic typing has led to the assignment of a label to a word, which label contradicts the label contained in the dictionary or identified by another dynamic strategy. This is the case, for example, when a word recorded as a location name in the dictionary appears as a person name in an unambiguous instance of the text. Let us consider the following sequence:

@ Washington, an Exchange allyn Seems

@ To Be Strong Candidate to Head SEC

@ . . .

<SO> WALL STREET JOURNAL (J), PAGE A2 </SO>

<DATELINE> WASHINGTON </DATELINE>

<TXT>

<p>

Consuela Washington, a longtime House staffer and an expert in securities laws, is a leading candidate to be chairwoman of the Securities and Exchange Commission in the Clinton administration.

</p>

It is clear that in this text Consuela Washington represents a person. The first instance of the word Washington is more of a problem in that the only information allowing a choice to be made in the sentence is world knowledge, viz. it is generally a person who runs an organization.

To define the scope of this type of problem and avoid the propagation of errors, the dynamic typing process is limited, in the event of conflict (that is to say, if a word has received a label which is in conflict with a label recorded beforehand for this word in the dictionary; this is the case for the word Washington in the above example), to the text being analyzed and not to the corpus as a whole. For example, the system will label all isolated instances of Washington as person name in the above text, but in the next text, if an isolated instance of the word Washington appears, the system will label it as location name, according to the dictionary. When more than one label has been found dynamically in the same text, an arbitrary choice is then made.

FIG. 3 illustrates the flowchart for conflict resolution in the typing of entities.

An example pseudocode implementing this function is given in Appendix 1.

The extraction module (20) includes a third program (INT_EXT, 213) to identify the relations between the entities for which the relevant instances have been selected by the program (212). The FACT_DB window in FIG. 5 shows the relations which have been established between the entities of the TAG_TEXT window.

This module includes three main sub-modules, the flowchart of which is represented in FIG. 5.

In the selection step (1000) of the method as represented in FIG. 8, the identification of the relations between the entities are processed during steps (1310), (1320), (1330) and (1400). Step (1310) (1st identification of relevant relations between entities) is automatic. Step (1320) (2nd identification of relevant relations between entities—Addition/Subtraction of relevant/non-relevant relations) is semi-automatic and assumes a step (1330) of interaction with the user. Step (1400) is for feeding the database (FACT_DB, 80) with the selected entities and the identified relations. The entity and relation field names are managed automatically and the fields of the database are then filled with their instances. The database (80) can in fact be operated by users who are not information processing specialists but who require structured information.

The device according to the invention also includes a learning module (LEARN_MOD, 30) which cooperates with the extraction module (20). This module receives at the input, in an asynchronous manner with the operation of the module (20), a collection of texts belonging to a given domain (DOM_TEXT, 50). This mode of asynchronous operation allows the knowledge base KB₂, (412) to be built containing the domain-specific dictionary and the knowledge base KB₃ (413) and the grammar rules specific to the same domain. It also enables relations that are characteristic of the domain, and which are stored in a database KB₅ (415), to be formulated.

The module (30) cooperates with the module (20) to enrich the knowledge bases (KB₂, KB₃, KB₅) as illustrated generically in FIG. 8 and on a specific example in FIG. 9.

This module includes three main sub-modules for which the sequencing flowchart is represented in FIG. 5: morphosyntactic analysis sub-module, sub-module for the linguistic analysis of elements in the form and form-filling sub-module. These sub-modules are sequenced together as a cascade: the analysis supplied at one given level is retrieved and extended to the next level.

### Morphosyntactic Analysis Sub-Module

The morphosyntactic analysis is made up of a tokenizer, a sentence splitter, an analyzer and a morphological labeler. In the example of FIG. 6, the annotations are presented in transducer form.

These modules are not specific to the extraction. They can be used in any other application requiring a conventional morphosyntactic analysis.

### Sub-Module for Local Linguistic Analysis for Identifying Information

The identification of elements of the form by linguistic analysis can be broken down into two steps: the first, generic, step is for analyzing named entities, and the second step, specific to a given corpus, is for typing the entities recognized previously and identifying other elements needed to fill the form.

Named entities are linked by means of more specific extraction schemes which are written by means of a set of transducers for assigning a label to a sequence of lexical items. These rules exploit the morphosyntactic analysis which took place beforehand. An example transducer is given in FIG. 7.

From a sentence such as:

“La compagnie Bridgestone Sports a déclaré vendredi qu'elle avait cr\acute{ee} une filiale commune à Taïwan avec une entreprise locale et une maison de commerce japonaise pour produire des clubs de golf à destination du Japon.”

This rule is used to infer the following relation:

Association(Bridgestone Sports, une entreprise locale).

The analysis, which at the start is generic, focuses gradually on certain characteristic elements of the text and transforms it into logical form.

### Extraction-Form-Filling Sub-Module

The last step involves simply retrieving within the document the relevant information in order to insert it into an extraction form. The partial results are merged into one single form per document.

An example pseudocode implementing these functions is given in Appendix 2.

The algorithms for selecting relevant entities are enhanced during step (1120) by interaction by the user (1130) who selects the relevant contexts and the non-relevant contexts of the instances of the entities. The new parameters of the algorithms are generated during step (2100) then stored during step (2200).

The algorithms for identifying relevant relations are enhanced during step (1320) by interaction by the user (1330) who identifies the relevant relations and the non-relevant relations. The new parameters of the algorithms are generated during step (2300) then stored during step (2400).

The mechanisms of steps (1120) and (1130) are illustrated by an example in FIG. 5.

1. Window (3100): the user supplies a semantic class to the system. For example, using verbs from speech: “affirmer” (to affirm), “déclarer” (to declare), “dire” (to say), etc.

2. Window (3200): this semantic class is projected onto the corpus (DOM_TEXT, 50) in order to gather all the contexts in which a given expression appears. Taking the example of speech verbs, this step ends with the formation of a list of all the contexts in which the verbs “affirmer” (to affirm), “déclarer” (to declare), “dire” (to say), etc. appear.

3. Window (3300): from the proposed contexts, the user distinguishes those which are relevant and those which are not relevant (such as the third item of the list).

4. Window (3400): the system uses the list of examples marked positive and negative to generate, from a set of knowledge for the domain: (essentially linguistic rules), a state machine covering most of the contexts marked positively while excluding those marked negatively.

A transducer describes a linguistic expression and is generally read from left to right. Each box describes a linguistic item and is linked to the next element by a line. A linguistic item can be a character string (que, de), a lemma (<avoir> may equally well denote the form a as the form avait or aurons), a syntactic category (<V> denotes any verb), a syntactic category Accompanied by semantic lines (<N+ProperName> denotes, within nouns, only proper names). The grayed elements (à_obj) denote a call to a complex structure described in another transducer (recursivity). The elements that Are searched for are included between the tags <key> and </key> which are introduced for later processing.

5. Window (3500): the user outputs the result state machine and if necessary makes slight alterations. The learning corpus is first subject to a preprocessing which aims to eliminate non-essential complements. This step is performed by projecting onto the text (TEXT, 10) in delete mode (the transition of a state machine to delete mode is used to obtain a text in which the sequences recognized by the state machine have been deleted) the fixed adverb dictionaries and grammars designed to identify adjunct elements. The knowledge base state machines are then, in their turn, projected onto the database of examples. Two state machines (3510, 3520) emerge from the linguistic knowledge database. The states of the state machine (3511, 3521) call on sub-graphs using indications supplied by the functional labeling, for the recognition of indirect objects introduced by the preposition “à” (3511) and inverted subjects (3521).

This strategy enables coverage of new positive contexts illustrated in the window (3600).

The state machine leads to the structure represented in the window (3700). This master state machine is inferred from the examples database for the recognition of speech verbs. The inferred state machine is complex. It covers the examples database and will feed the extraction system.

[image]

[image]

[image]

[image]

[image]

[image]

[image]

[image]

[image]

1. A device for extracting information from a text (10) comprising an extraction module (20) and a learning module (30) cooperating with each other comprising means (212) for automatically selecting in the text (10) the contexts of instance of classes/entities of information to be extracted, for automatically selecting from these contexts those which are relevant for a domain and for enabling the user to modify this latter selection in a manner such that the learning module (30) will improve the next output (70, 80) of the extraction module (20), characterized in that the extraction module (20) additionally comprises means (213) for identifying relations existing in the text (10) between the relevant entities at the output of the means (212).

2. The information extraction device as claimed in claim 1, characterized in that the selection module (20) comprises a program (211) able to recognize the structure of the text (10).

3. The information extraction device as claimed in claim 1 or claim 2, characterized in that the selection module (20) simultaneously applies rules defined a priori and rules calculated by the learning module

4. The information extraction device as claimed in one of the preceding claims, characterized in that the selection module (20) is able to automatically apply similarity rules inferred from the context.

5. The information extraction device as claimed in one of the preceding claims, characterized in that the learning module (30) and the selection module (20) are able to manage homonyms belonging to different classes/entities.

6. The information extraction device as claimed in one of the preceding claims, characterized in that the learning module (30) is capable of not generating new rules from non-essential elements.

7. The information extraction device as claimed in one of the preceding claims, characterized in that the learning module (30) is able to generate new rules from positive selections and from negative selections made by the user.

8. The information extraction device as claimed in one of the preceding claims, characterized in that the outputs of the selection module can be arranged in a file or a database.

9. The information extraction device as claimed in one of the preceding claims, characterized in that the vocabulary and grammar of the domain are represented by finite state machines.

10. The information extraction device as claimed in the preceding claim, characterized in that the finite state machines are represented in the form of graphs to the user.

11. A method for extracting information from a text (10) comprising a learning process (2000) and a selection process (1000), said selection process comprising a step (1100) of automatic selection in the text of contexts of instance of classes/entities of the information to be extracted, a step (1110) of automatic selection from these contexts of those which are relevant for a domain and a step (1130) of modification by the user of outputs of the previous step, the modified outputs being taken into account in the learning process (2000) to improve the next result of the selection process (1000), characterized in that the selection process (1000) additionally comprises steps (1310, 1320, 1330) to identify the relations existing in the text (10) between the relevant entities at the output of the steps (1120, 1130) of the selection process (1000).

12. The information extraction method as claimed in claim 11, characterized in that the selection process (1000) comprises a step for recognizing the structure of the text (10).

13. The information extraction method as claimed in claim 11 or claim 12, characterized in that the selection process (1000) simultaneously applies rules defined a priori and rules calculated by the learning module (30).

14. The information extraction method as claimed in one of claims 11 to 13, characterized in that the selection process (1000) can include the automatic application of similarity rules inferred from the context.

15. The information extraction method as claimed in one of claims 11 to 14, characterized in that the learning process (2000) and the selection process (1000) enable the management of homonyms belonging to different classes.

16. The information extraction method as claimed in one of claims 11 to 15, characterized in that the learning process (2000) is capable of not generating new rules from non-essential elements.

17. The information extraction method as claimed in one of claims 11 to 16, characterized in that the learning process (2000) is able to generate new rules from positive selections and from negative selections made by the user.

18. The information extraction method as claimed in one of claims 11 to 16, characterized in that the outputs of the selection process (1000) can be arranged in a file or a database (80).
